(19) United States
(12) Patent Application Publication
(10) Pub. No.: US 2023/0133661 A1
(43) Pub. Date: May 4, 2023

(54) MODULAR WHEEL ARRANGEMENT

(71) Applicant: Commonwealth Scientific and Industrial Research Organisation, Acton, Australian Capital Territory (AU)

(72) Inventors: Paul Damien FLICK, Acton (AU); Tirthankar BANDYOPADHYAY, Acton (AU); Ryan STEINDL, Acton (AU); Troy CORDIE, Acton (AU)

(21) Appl. No.: 17/910,602

(22) PCT Filed: Mar. 9, 2021
(86) PCT No.: PCT/AU2021/050205

§ 371 Date: Sep. 9, 2022

(30) Foreign Application Priority Data
Mar. 10, 2020 (AU) 2020900729

(51) Int. Cl. B25J 9/16; B60B 33/02

(52) U.S. Cl. CPC B25J 9/1697; B60B 33/026; B25J 9/1666; B25J 13/085

(57) ABSTRACT

The present invention provides a system for moving an object within an environment, wherein the system includes: one or more modular wheels configured to move the object, wherein the one or more modular wheels include: a body configured to be attached to the object; a wheel; a drive configured to rotate the wheel; a sensor mounted to the body; and, one or more processing devices configured to control the one or more modular wheels in accordance with signals from the sensor to thereby rotate the wheel and move the object.

### BACKGROUND OF THE INVENTION

The present invention relates to a modular wheel arrangement, and a method and system for operating a modular wheel arrangement to thereby move an object within an environment.

### DESCRIPTION OF THE PRIOR ART

The reference in this specification to any prior publication (or information derived from it), or to any matter which is known, is not, and should not be taken as an acknowledgment or admission or any form of suggestion that the prior publication (or information derived from it) or known matter forms part of the common general knowledge in the field of endeavour to which this specification relates.

“Modular Field Robots for Extraterrestrial Exploration” by Troy Cordie, Tirthankar Bandyopadhyay, Ryan Steindl, Ross Dungavell describes a design and controller architecture for modular field robots that can be rapidly assembled in a variety of functional configurations. A modular wheel design and a distributed controller architecture is provided that is able to create a range of bespoke multi-wheeled configurations capable of traversal on a variety of terrains during simulated failure scenarios. The self-contained wheeled unit has energy, computation communication, and actuation modules and does not require any modification or physical customization in the field during deployment enabling a seamless plug and play behavior. The hierarchical control structure runs a body controller node that decomposes a whole body motion requested from a higher level planner to generate a sequence of actuation goals for each of the modules, while a local controller node running on each of the modules ensures that the desired actuation is adapted to the configuration, load and terrain characteristics.

### SUMMARY OF THE PRESENT INVENTION

In one broad form, an aspect of the present invention seeks to provide a system for moving an object within an environment, wherein the system includes: one or more modular wheels configured to move the object, wherein the one or more modular wheels include: a body configured to be attached to the object; a wheel; a drive configured to rotate the wheel; and, a sensor mounted to the body; and, one or more processing devices configured to control the one or more modular wheels in accordance with signals from the sensor to thereby rotate the wheel and move the object.

In one embodiment at least one modular wheel includes a steering drive configured to adjust an orientation of the wheel and wherein the one or more processing devices are configured to control the steering drive to thereby change an orientation of the wheel and thereby steer the object.

In one embodiment the one or more processing devices are configured to: receive sensor signals from one or more sensors; analyse the sensor signals; generate a wheel configuration indicative of a wheel configuration of the one or more modular wheels; and, control the one or more modular wheels in accordance with the wheel configuration.

In one embodiment the one or more processing devices are configured to generate a wheel configuration for each modular wheel.

In one embodiment the wheel configuration is indicative of at least one of: a position of one or more modular wheels relative to each other; a position of one or more modular wheels relative to one or more passive wheels; a position of one or more modular wheels relative to the object; a position of one or more modular wheels relative to an environment; a position of one or more modular wheels relative to one or more markers; an orientation of one or more modular wheels relative to each other; an orientation of one or more modular wheels relative to one or more passive wheels; an orientation of one or more modular wheels relative to the object; an orientation of one or more modular wheels relative to an environment; an orientation of one or more modular wheels relative to one or more markers; a wheel identity of each modular wheel; and, a relative position, relative orientation and wheel identity of each modular wheel.

In one embodiment the one or more markers are at least one of: provided on the object; provided in the environment; provided on one or more modular wheels; one or more modular wheels; one or more passive wheels; one or more active markers; a part of the object; Fiducial markers; and, April tags.

In one embodiment the sensor is an imaging device that is configured to capture one or more images and wherein one or more processing devices are configured to generate the wheel configuration by analyzing the one or more images.

In one embodiment the one or more processing devices are configured to: analyze images captured with at least one modular wheel in multiple orientations; and, use the images to generate the configuration data.

In one embodiment the one or more processing devices are configured to: monitor images from an imaging device as an orientation of the respective modular wheel is varied; and, determine when an image including a marker is captured.

In one embodiment the one or more processing devices are configured to: identify an image including a marker; determine a wheel orientation when the identified image was captured; and, use the wheel orientation to generate the wheel configuration.

In one embodiment the one or more processing devices are configured to: analyze images to identify at least one marker parameter; and, generate the wheel configuration using the marker parameter.

In one embodiment the marker parameter includes at least one of: a marker size; a marker shape; a marker position; a marker colour; a marker illumination sequence; a marker pattern; and a marker orientation.

In one embodiment the one or more processing devices are configured to: determine when an image including a marker is captured; use the image of the marker to determine a wheel position and orientation relative to the marker; and, use the wheel position and orientation for each modular wheel to generate the wheel configuration.

In one embodiment the one or more processing devices are configured to: determine when a first imaging device of a first modular wheel captures an image of a second modular wheel; analyse one or more images from the first modular wheel to determine a wheel identity of at least one second modular wheel; and, generate a wheel configuration at least in part using the determined wheel identity.

In one embodiment the one or more processing devices are configured to: cause movement of one or more second modular wheels; analyse multiple images from the first imaging device to detect movement of the at least one second modular wheel; and, use results of the analysis to determine an identity of the at least one second wheel.

In one embodiment the one or more processing devices are configured to determine a wheel identity of at least one second modular wheel using visual markings associated with the at least one second modular wheel.

In one embodiment the sensor is a force sensor that is configured to capture forces between the body and the object and wherein one or more processing devices are configured to generate the wheel configuration by analyzing captured forces.

In one embodiment the one or more processing devices are configured to: control the one or more modular wheels to cause the modular wheels to perform defined movements; and, analyze captured forces in accordance with the defined movements to generate the configuration data.

In one embodiment the one or more processing devices are configured to: cause a first modular wheel to perform defined movements; and, use captured forces from the force sensors of the first and one or more second modular wheels to thereby generate the wheel configuration.

In one embodiment the one or more processing devices are configured to: receive sensor signals from one or more sensors; analyse the sensor signals; identify instructions from the sensor signals; and, control the one or more modular wheels in accordance with the instructions.

In one embodiment the sensor signals are indicative of markings provided in the environment.

In one embodiment the sensor includes an imaging device and wherein the one or more processing devices are configured to analyse images captured by the imaging device to detect the markings.

In one embodiment the markings include line markings in the environment and the one or more processing devices are configured to control the one or more modular wheels to move the object in accordance with the line markings.

In one embodiment the line markings include encoded line markings and the one or more processing devices are configured to follow a route in accordance with the encoded line markings.

In one embodiment the one or more processing devices are configured to: determine an object configuration; and, control the modular wheels at least partially in accordance with the object configuration.

In one embodiment the object configuration is indicative of at least one of: a physical extent of the object; and, movement parameters associated with the object.

In one embodiment the sensor is an imaging device that is configured to capture one or more images and wherein one or more processing devices are configured to determine the object configuration by analyzing the one or more images.

In one embodiment the one or more processing devices are configured to: determine an identity for at least one of: the object; and, for at least one modular wheel attached to the object; and, determine the object configuration at least in part using the object identity.

In one embodiment the one or more processing devices are configured to: determine routing data indicative of at least one of: a travel path; and, a destination; and, control at least one of the drive and a steering drive in accordance with the routing data and the wheel configuration.

In one embodiment the routing data is indicative of at least one of: a permitted object travel path; permitted object movements; permitted proximity limits for different objects; permitted zones for objects; and, denied zones for objects.

In one embodiment the one or more processing devices are configured to: determine an identity for at least one of: the object; and, for at least one modular wheel attached to the object; and, determine the routing data at least in part using the object identity.

In one embodiment the one or more processing devices are configured to determine the object identity at least in part using a network identifier.

In one embodiment the one or more processing devices are configured to determine the object identity using machine readable coded data.

In one embodiment the machine readable coded data is visible data, the sensors are imaging devices and wherein the one or more processing devices are configured to analyse images captured by the imaging devices to detect the machine readable coded data.

In one embodiment the machine readable coded data is encoded on a tag, and wherein the one or more processing devices are configured to receive signals indicative of the machine readable coded data from a tag reader.

In one embodiment the tags are at least one of: short range wireless communications protocol tags; RFID tags; and, Bluetooth tags.

In one embodiment the system includes one or more passive wheels mounted to the object.

In one embodiment the at least one modular wheel includes a transceiver configured to communicate wirelessly with the one or more processing devices.

In one embodiment the one or more processing devices include a controller associated with each of the one or more modular wheels.

In one embodiment the one or more processing devices include a control processing device configured to: generate control instructions at least in part using the determined wheel configuration; and, provide the control instructions to one or more controllers, the one or more controllers being responsive to the control instructions to control one or more respective drives and thereby move the object.

In one embodiment the one or more processing devices are configured to provide respective control instructions to each controller to thereby independently control each modular wheel.

In one embodiment the one or more processing devices are configured to provide control instructions to the one or more controllers and wherein the one or more controllers communicate to independently control each modular wheel.

In one embodiment the control instructions include at least one of: a wheel orientation for each wheel; and, a rate of rotation for each wheel.

In one embodiment the control instructions include a direction and rate of travel for the object, and wherein the controllers use the control instructions to determine at least one of: a wheel orientation for each wheel; and, a rate of rotation for each wheel.

In one embodiment the system is configured to steer the object by at least one of: differentially rotating multiple modular wheels; and, changing an orientation of one or more modular wheels.

In one embodiment at least one modular wheel includes a mounting attached to the body, the mounting being configured to couple the body to the object.

In one embodiment the one or more modular wheels include a power supply configured to power at least one of: the drive; a controller; a transceiver; and, a steering drive.

In one embodiment the system includes a plurality of modular wheels.

In one embodiment the object includes a platform and wherein the at least one modular wheel is attached to the platform.

In one embodiment the object includes an item supported by the platform.

In one broad form, an aspect of the present invention seeks to provide a method for moving an object within an environment, wherein the method includes: providing one or more modular wheels configured to move the object, wherein the one or more modular wheels include: a body configured to be attached to the object; a wheel; a drive configured to rotate the wheel; and, a sensor mounted to the body; and, in one or more processing devices, controlling the one or more modular wheels in accordance with signals from the sensor to thereby rotate the wheel and move the object.

In one broad form, an aspect of the present invention seeks to provide a modular wheel for moving an object within an environment, wherein the modular wheel includes: a body configured to be attached to the object; a wheel; a drive configured to rotate the wheel; and, a sensor mounted to the body.

It will be appreciated that the broad forms of the invention and their respective features can be used in conjunction and/or independently, and reference to separate broad forms is not intended to be limiting. Furthermore, it will be appreciated that features of the method can be performed using the system or apparatus and that features of the system or apparatus can be implemented using the method.

### BRIEF DESCRIPTION OF THE DRAWINGS

Various examples and embodiments of the present invention will now be described with reference to the accompanying drawings, in which: —

FIG. 1A is a schematic end view of an example of a modular wheel;

FIG. 1B is a schematic side view of the modular wheel of FIG. 1A;

FIG. 1C is a schematic end view of modulars wheel of FIG. 1A mounted to an object;

FIG. 1D is a schematic side view of the object of FIG. 1C;

FIG. 2 is a flowchart of a first example of a control process for moving an object within an environment;

FIG. 3 is a flowchart of a second example of a control process for moving an object within an environment;

FIG. 4A is a schematic end view of a specific example of a modular wheel;

FIG. 4B is a schematic side view of the modular wheel of FIG. 4A;

FIG. 5 is a schematic diagram of an example of a wheel controller for the modular wheel of FIGS. 4A and 4B;

FIG. 6A is a schematic diagram of an example of a wheel controller architecture for moving an object;

FIG. 6B is a schematic diagram of a further example of a wheel controller architecture for moving an object;

FIGS. 7A to 7D are schematic diagrams of examples of different wheel control configurations;

FIG. 8A is a first schematic side view of a further specific example of a modular wheel;

FIG. 8B is a schematic front view of the modular wheel of FIG. 8A;

FIG. 8C is a second schematic side view of the modular wheel of FIG. 8A;

FIG. 8D is a schematic front top side isometric view of the modular wheel of FIG. 8A;

FIG. 9 is a flowchart of an example of a control process for moving an object within an environment using marker detection;

FIG. 10 is a flowchart of an example of a control process for moving an object within an environment using wheel detection;

FIG. 11 is a flowchart of an example of a control process for moving an object within an environment using force detection;

FIG. 12 is a flowchart of an example of a control process for moving an object within an environment using an object configuration; and,

FIG. 13 is a flowchart of an example of a control process for moving an object within an environment using routing information.

### DETAILED DESCRIPTION OF THE PREFERRED EMBODIMENTS

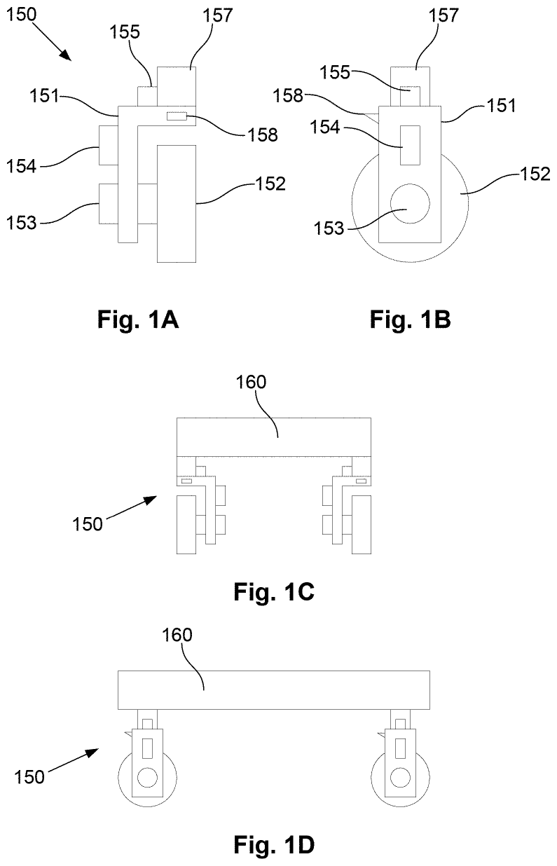

An example of a modular wheel for moving an object within an environment will now be described with reference to FIGS. 1A to 1D.

In this example, the modular wheel 150 includes a body 151 configured to be attached to an object, and a wheel 152, typically supported by the body 151 using an axle or similar. A drive 153, such as a motor, is provided with the drive 153 being configured to rotate the wheel 152, allowing movement of the modular wheel 150 over a surface. The body 151 could be of any appropriate form and could be attached to the object in any manner, including through the use of a mounting bracket 157 or similar.

In one example, the mounting bracket 157 is optionally rotatably mounted to the body 151, allowing an orientation (“heading”) of the modular wheel to be adjusted using a steering drive 155, so that the modular wheel 150 can be steered. It will be appreciated however that this may not be required, for example in skid steer arrangements, or the like, as described in more detail below.

The modular wheel further includes a sensor 158 mounted to the body 151. The sensor is used to allow the modular wheel to be configured and/or controlled and the nature of the sensor 158, the mounting location and the manner in which this is used will vary depending on the preferred implementation. For example, the sensor 158 could be an imaging device used to sense markings or features in the environment around the wheel, in which case the imaging device is typically attached to an outside of the body 151. Alternatively, however, the sensor 158 could be a force sensor, and in particular a torque sensor that is configured to sense forces between the object and modular wheel, in which case the sensor could be positioned between the bracket 157 and body 151. It will also be appreciated that multiple sensors could be employed and that use of the singular term could encompass multiple sensors.

In use, one or more modular wheels can be attached to an object to allow the object to be moved, and an example of this will now be described with reference to FIGS. 1C and 1D.

In this example, an object 160 in the form of a platform is shown, with four modular wheels 150 being mounted to the platform, allowing the platform to be moved by controlling each of the four modular wheels 150. However, a wide range of different arrangements are contemplated, and the above example is for the purpose of illustration only and is not intended to be limiting.

For example, the system could use a combination of driven modular wheels and passive wheels, where the one or more modular wheels could be used to provide motive force, whilst passive wheels are used to fully support the object, for example allowing a singular modular wheel to be deployed with multiple passive wheels in order to support and move an object. Steering could be achieved by steering individual wheels, as will be described in more detail below and/or through differential rotation of different modular wheels, for example using skid steer arrangements, or similar.

In the current example, the modular wheels are shown provided proximate corners of the platform. However, this is not essential and the modular wheels could be mounted at any location, assuming this is sufficient to adequately support the platform.

Whilst the current example focuses on the use of a platform, the modular wheel could be used with a wide range of different objects. For example, using the wheels with platforms, pallets, or other similar structures, allows one or more items to be supported by the platform, and moved collectively. Thus, wheels could be attached to a pallet supporting a number of items, allowing the pallet and items to be moved without requiring the use of a pallet jack or similar. In this instance, the term object is intended to refer collectively to the platform/pallet and any items supported thereon. Alternatively, the wheels could be attached directly to an item, without requiring a platform, in which case the item is the object.

The nature of objects that can be moved will vary depending on the preferred implementation, intended usage scenario, and the nature of the environment. Particular example environments include factories, warehouses, storage environments, or similar, although it will be appreciated that the techniques could be applied more broadly, and could be used in indoor and/or outdoor environments. Similarly, the objects could be a wide variety of objects, and may for example include items to be moved within a factory, such as components of vehicles, or the like. However, it will be appreciated that this is not intended to be limiting.

Each modular wheel 150 includes a controller 154 that is configured to control the drive 153 to allow the wheel 152 to be rotated as required, and optionally to control the steering drive 155 to allow the orientation of the wheel 152 to be adjusted.

The controller could be of any appropriate form but in one example is a processing device that executes software applications stored on non-volatile (e.g., hard disk) storage, although this is not essential. However, it will also be understood that the controller could be any electronic processing device such as a microprocessor, microchip processor, logic gate configuration, firmware optionally associated with implementing logic such as an FPGA (Field Programmable Gate Array), or any other electronic device, system or arrangement.

In use, control of the wheels, and hence movement of an object, is generally performed by one or more processing devices, including controllers 154 associated with one or more modular wheels 150, and optionally one or more separate processing systems, with processing being distributed amongst the processing devices as required. For ease of illustration, the following description will refer generally to one or more processing devices, with the intention this could encompass processing being performed solely within one or more controllers associated with one or more modular wheels and/or with one or more processing systems. Thus, reference to the singular should be deemed to encompass the plural arrangement and vice versa, so that the term processing device will be understood to include arrangements having multiple processing devices.

In any event, the above described arrangements allow one or more processing devices to be configured to control the one or more modular wheels 150 in accordance with signals from the sensor(s) 158 to rotate and/or steer the wheel(s) 152 and thereby move the object. The manner in which control is implemented will vary depending on the preferred implementation and examples of this will now be described in further detail.

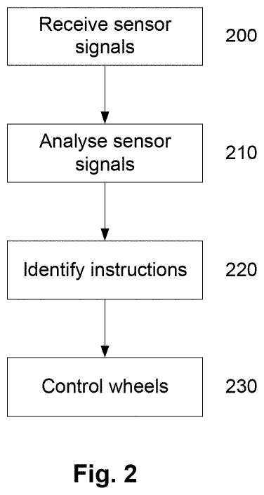

A first example of a control process will now be described with reference to FIG. 2, in which instructions are identified from the environment.

In this example, at step 200, the processing devices receive sensor signals from one or more sensors, and then analyse the sensor signals at step 210. At step 220, the processing devices identify instructions from the sensor signals and then control the one or more modular wheels in accordance with the instructions at step 230. Accordingly, in this instance, instructions are encoded within the environment, typically using machine readable markings, such as coded data or similar, allowing these to be detected and used to control movement of the object.

The exact manner in which this is performed will depend on how the instructions are encoded and sensed. For example, at a most basic level, this approach could include line following, with routes in the form of travel paths being encoded within the environment using visible and/or non-visible lines marked on a surface. Thus, in one example, the sensors 158 are imaging devices and the processing devices are configured to analyse images captured by the imaging devices 158 to detect the markings, allowing these to be interpreted and used to guide movement of the object. This arrangement is particularly useful in the context of a single modular wheel used together with passive wheels in order to allow an object to be moved using a line following process, although it will be appreciated that this can also be used with arrangements including multiple modular wheels.

Beyond basic line marking, a system of encoded lines could be used, for example, using coloured or selectively broken lines, allowing more complex routing to be performed. This could include having the processing devices provided with routing information defining a sequence of coloured lines that should be followed. For example, a junction may be defined including different coloured exit paths, with the processing devices analysing captured images to detect the different coloured lines, ascertaining which line to follow using the routing information. This allows different colour sequences to be used to define different routes within an environment, whilst using a common set of markings.

It will also be appreciated however that other techniques could be used. For example, non-visible lines could be magnetically encoded or visible codes, such as arrows, could be used to define routing information. Alternatively, tags such as RFID tags could be provided in the environment and encoded with navigation information that could be sensed by one or more of the modular wheels and used to control movement of the object.

In each of these scenarios, and particularly in line following, one of the modular wheels could be designated as a primary wheel, with this following the line, and other wheels following the lead wheel. This is not essential however, and any suitable approach could be used.

In any event, it will be appreciated that integrating the sensor into the modular wheel can allow one or more modular wheels to be attached to an object, thereby allowing the object to be moved in accordance with instructions encoded within the environment.

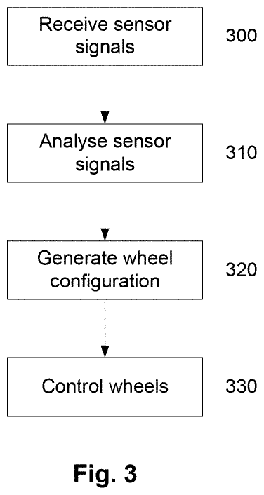

A second example control process will now be described with reference to FIG. 3.

In this example, sensor signals are used to generate a wheel configuration, which is then used in controlling the modular wheels.

In this example, the processing devices are configured to receive sensor signals from one or more sensors at step 300, and analyse the sensor signals at step 310. Results of the analysis are used to generate a wheel configuration indicative of a wheel configuration of the one or more modular wheels at step 320, with the wheel configuration being used to subsequently control operation of the wheels at step 330.

Accordingly, in this instance, the processing devices are configured to use the sensor signals to determine a wheel configuration, such as the layout of the wheels, and allow this information to be used to control the wheels. Thus, identifying the relative positioning and/or orientation of the wheels allows the processing devices to assess the orientation and amount of rotation required for each wheel in order to cause the object to move in a desired manner.

Once this information has been derived, a route for the object can be translated into control inputs for each of the individual modular wheels, thereby allowing routes to be followed.

Thus, the ability to detect a wheel configuration in this manner, allows modular wheels to be localised relative to each other by sensing information using the sensors, which in turn allows the modular wheels to be attached to an object in any location, without requiring manual positioning and/or configuration. This in turn allows the system to control the wheels to allow the object to follow a desired path, whilst simplifying the set-up process.

It will be appreciated that whilst the above described processes are described independently, this is not essential and the two approaches could be used in conjunction, for example using the second approach to determine a wheel configuration, and then using the wheel configuration to control the wheels when line following using the first approach, or similar.

A number of further features will now be described.

The wheel configuration can define the wheel position and/or layout in a number of manners and could be indicative of one or more of a position of one or more modular wheels relative to each other, a position of one or more modular wheels relative to one or more passive wheels, a position of one or more modular wheels relative to the object, a position of one or more modular wheels relative to an environment, or a position of one or more modular wheels relative to one or more markers. Similarly, the wheel configuration can be indicative of an orientation of one or more modular wheels relative to each other, an orientation of one or more modular wheels relative to one or more passive wheels, an orientation of one or more modular wheels relative to the object, an orientation of one or more modular wheels relative to an environment, or an orientation of one or more modular wheels relative to one or more markers. The wheel configuration may also be indicative of a wheel identity of each modular wheel, although alternatively a respective wheel configuration may be determined for each modular wheel.

In one preferred example, the wheel configuration defines a relative position, relative orientation and wheel identity for each modular wheel. This allows instructions to be provided to each modular wheel to allow the wheels to be positioned and moved relative to each other, in order to achieve desired overall movement of the object.

In one example, the system generates a wheel configuration for each modular wheel, although this is not essential and alternatively a single wheel configuration could be determined for all the modular wheels attached to an object.

Where markers are used to define the wheel configuration, the markers could be provided on the object, within the environment, or on one or more modular wheels. The markers could be of any appropriate form, and in one example, may include a unique feature on the object or in the environment, which could be used to identify relative positions and orientations of the wheels. For example, the markers can include machine readable coded data which can be used to impart additional information and thereby assist in localising the wheels. In one example, the markers include visual coded data, such as one or more fiducial markers, that allow the wheel to locate itself relative to the markers. In one particular example, the machine readable coded data includes an AprilTag, described in “AprilTag: A robust and flexible visual fiducial system” by Edwin Olson in Proceedings of the IEEE International Conference on Robotics and Automation (ICRA), 2011. However, this is not essential and other markers that allow for localisation could be used.

The above examples describe passive markers, but it will be appreciated that active markers, such as illumination sources, LEDs, or the like, could be used, which can be detected based on emitted visual radiation. In a basic example, an LED can be used to assist in detection of the marker, but it will be appreciated that these can also be used to encode information, for example using different colours, illumination sequences, or the like. Additionally, and/or alternatively, markers could be in the form of displays, such as LCD, LED, or elnk displays, which could display visual markings, including but not limited to AprilTag or fiducial markings.

In any event, in these examples, the sensor is an imaging device that is configured to capture one or more images, with the processing devices being configured to generate the wheel configuration by analyzing the one or more images. In particular the processing devices analyse the images in order to detect the markers, and then use information regarding the relative position of each of the modular wheels to the marker to ascertain the relative position of the modular wheels.

As the position of the marker in the environment and the initial position of the modular wheels are not initially known, in one example this process involves analyzing images captured with at least one modular wheel in multiple orientations and then using the images to generate the configuration data. Specifically, different images can be analysed in order to detect the marker. In one particular example, this process is performed by progressively adjusting an orientation of the modular wheel, capturing and analysing images as the wheel is moved, with this process continuing until the marker(s) is detected.

When the marker is identified in one of the images, the processing devices can be configured to determine a wheel orientation when the image was captured and then use the wheel orientation to generate the wheel configuration. In this regard, if sensors on different modular wheels are used to capture images of the same marker, the orientations of each modular wheel can be used to help identify relative positions of the wheel.

However, it will be appreciated that capturing wheel orientations relative to one marker will only provide limited information, and in particular will not be sufficient to uniquely locate each of the modular wheels. Accordingly, in one example the process is further assisted by capturing additional information.

In one example, this can be achieved by detecting different markers at different locations within the environment, and then using this information to triangulate the position of the wheels. Additionally and/or alternatively, the processing devices can be configured to analyze images to identify at least one marker parameter, such as a size, shape, position, colour, illumination sequence, pattern or orientation of the marker, and then use the parameter to generate the wheel configuration. Thus, for example, the relative size of a marker captured from different modular wheels can be used in order to calculate relative distances of the wheels from the markers. Similarly, images captured of AprilTags or fiducial markers can be used to ascertain additional information regarding an orientation of the marker relative to the wheel, which can further assist in accurately resolving the relative locations of the wheels.

Markers such as LEDs can be used, with the colour and/or illumination sequence (such as a pattern of flashes), being used to encode information, for example for identification purposes. Thus, for example, different wheels could include LEDs mounted thereon which have a different colour and/or are illuminated with a different sequence of flashes, thereby allowing different wheels to be distinguished. LEDs could be provided on wheels at different locations, with different colours being used to identify different orientations of the wheels. Additionally, and/or alternatively a layout of different LEDs could be provided, with colours and/or illumination sequences allowing the different LEDs to be identified thereby resolving an overall orientation of the layout.

Thus, it will be appreciated that capturing images of markers, particularly in the form of coded data, can be used to localize the wheels relative to each other, and thereby generate the configuration data.

In another example, the markers could include other modular wheels. In this instance, modular wheels could be adapted to progressively rotate until another modular wheel is imaged, with this being repeated so that each modular wheel images the other modular wheels, with the relative wheel orientations then being used to resolve the wheel configuration.

As part of this process, it is typically necessary to identify each of the other wheels, so that the wheel identity can be used in generating the wheel configuration, specifically to ensure the wheel layout is correctly resolved. In one example, this is achieved by having a first imaging device of a first modular wheel capture an image of a second modular wheel. The processing devices can then cause movement of one or more second modular wheels, for example causing one or more of the other modular wheels to re-orientate in turn, with the processing devices analyzing multiple images from the first imaging device to detect movement of the at least one second modular wheel, and thereby determine an identity of the at least one second wheel. Alternatively, each of the other modular wheels can be instructed to turn by different amounts, with images captured by the first imaging device being used to measure a degree of wheel movement of the detected second modular wheel, and thereby identify the second modular wheel.

Additionally, and/or alternatively, the processing devices can be configured to determine a wheel identity of at least one second modular wheel using visual markings associated with the at least one second modular wheel. For example, modular wheels could include unique identifiers, such as QR codes, AprilTags or the like, so that the identity of different modular wheels can be determined using the identifier. Alternatively, other techniques could be used, such as providing a range of different coloured modular wheels, with an object being fitted with different coloured wheels, so that each wheel can be uniquely identified based on the wheel colour.

It will be appreciated that in the above example, particularly when detecting other modular wheels, it may be necessary to apply a distance threshold in order to exclude wheels on other objects that are present within the environment.

Furthermore, whilst the above described process has focused in detecting other modular wheels, it will also be appreciated that passive wheels could also be detected. In this instance, and depending on the relative number of modular and passive wheels, this may require that passive wheels include additional markings, such as AprilTags or similar, to allow the relative position of the passive and modular wheels to be fully resolved.

In another example, as opposed to using visual sensing, the sensor could be a force sensor that is configured to capture forces between the body and the object, such as a torque that arises due to the modular wheel applying a force to the body and/or the body applying a force to the modular wheel. In this example, the processing devices can be configured to generate the wheel configuration by analyzing the forces generated under a range of conditions. This can be achieved by having the processing devices control the one or more modular wheels to cause the modular wheels to perform defined movements, with forces generated as a result of the movements being analyzed in accordance with the defined movements to generate the configuration data. For example, if a first modular wheel is controlled to perform defined movements, such as a defined rotation to move the object in a given direction, whilst the remaining wheels are stationary, this will result in different torques being generated in each of the modular wheels, depending on the wheel layouts. Capturing these forces using the force sensors and repeating this for multiple different movements of different wheels then allows the relative positions of the modular wheels to be resolved.

Accordingly, in one example, the processing devices are configured to cause the modular wheels to undergo a sequence of defined movements, with the resulting measured forces being resolved to allow the relative wheel positions and hence wheel configuration to be derived.

Accordingly, a number of different mechanisms have been described that allow relative wheel positions to be determined. Whilst these approaches could be used independently, this is not essential and alternatively, these approaches could be used in conjunction. For example, detection of markers could be used to define an initial rough wheel configuration, with detection of forces being used to further refine the configuration. In one example, this allows an initial rough assessment of wheel configuration to be used to allow the object to be moved, with additional force measurements being captured as the object is moved in use, thereby further improving the wheel configuration over time.

In addition to determining a wheel configuration, the processing devices may also require information regarding the object in order to safely move the object. For example, if the object overhangs one or more of the wheels, this information may be required in order to navigate within an environment. Accordingly, in one example, the processing devices are configured to determine an object configuration and then control the modular wheels at least partially in accordance with the object configuration. The object configuration could be indicative of anything that can influence movement of the object, and could include an object extent such as a size, shape, height, or the like, as well as parameters that impact on movement of the object, such as an object weight, stability, or the like. This allows the processing device to take these factors into account, when controlling the wheels, thereby ensuring the object does not impact on other objects or parts of the environment, tip over, or the like.

The object configuration could be determined in any appropriate manner and could be manually input by an operator, or determined automatically, for example using the sensors. For example, when the sensor is an imaging device, the processing devices can be configured to determine the object configuration by analyzing the one or more images, so that an object extent could be detected by having the sensors image edges of the object, or markers attached thereto, or the like. Similarly, in the case of the sensors being force sensors, these could be used to establish a weight and/or centre of mass of the object.

Additionally, and/or alternatively, the processing devices could be configured to determine an identity of the object, and/or a modular wheel attached to the object, and then determine the object configuration based on the identity, for example by retrieving a previously stored object configuration using the object identity. The object identity could be determined in any one of a number of manners depending on the preferred implementation. For example, the processing devices can be configured to determine the identity using machine readable coded data. This could include visible coded data provided on the object and/or wheels, such as a barcode, QR code or more typically an April Tag, which can then be detected by analysing images to identify the visible machine readable coded data in the image allowing this to be decoded by the processing device. In another example objects and/or modular wheels may be associated with tags, such as short range wireless communication protocol tags, RFID (Radio Frequency Identification) tags, Bluetooth tags, or similar, in which case the machine readable coded data could be retrieved from a suitable tag reader.

In order to control movement of the object, the processing devices can be configured to determine routing data indicative of a travel path and/or a destination, and then generate control instructions in accordance with the routing data. The routing data could be determined in any appropriate manner and could be defined manually by an operator, or retrieved from a data store, such as a database, using an object and/or wheel identity. In this latter case, the identity could be determined in a manner similar to that described above.

In addition to indicating a travel path and/or destination, the routing data could also be indicative of a permitted object travel path, permitted object movements, permitted proximity limits for different objects, permitted zones for objects or denied zones for objects. This additional information could be utilised in the event a preferred path cannot be followed, allowing alternative routes to be calculated, for example to avoid obstacles, such as other objects.

Having determined the routing data, this is then typically processed using the wheel and/or object configuration, allowing the processing system to determine the wheel orientations and rotations required in order for the object to traverse the path.

In one example, the system includes one or more passive wheels mounted to the object. Such passive wheels could be multi-directional wheels, such as castor wheels, or similar, in which case the controller(s) can be configured to steer the object through differential rotation of two or more modular wheels. Additionally, and/or alternatively, as mentioned above the modular wheel can include a steering drive configured to adjust an orientation of the wheel, in which case the controller(s) can be configured to control the steering drive to thereby change an orientation of the wheel, and hence direct movement of the movable object. It will also be appreciated that other configurations could be used, such as providing drive wheels and separate steering wheels. However, in general, providing both steering and drive in single modular wheels provides a greater range in flexibility, allowing identical modular wheels to be used in a range of different ways. This can also assist in addressing wheel failure, for example allowing different control modes to be used if one or more of the modular wheels fail.

In one example, each modular wheel typically includes a transceiver configured to communicate wirelessly with the one or more processing devices. This allows the modular wheels to communicate directly with each other and/or other processing devices, although it will be appreciated that this is not essential, and other arrangements, such as using a centralised communications module, mesh networking between multiple modular wheels, or the like, could be used.

Each modular wheel typically includes a power supply, such as a battery, configured to power the drive, the controller, the transceiver, steering drive, and any other components. Providing a battery for each wheel, allows each wheel to be self-contained, meaning the wheel need only be fitted to the object, and does not need to be separately connected to a power supply or other wheel, although it will be appreciated that separate power supplies could be used depending on the intended usage scenario.

In one example, the system includes a plurality of modular wheels and a central processing device is configured to provide respective control instructions to each controller to thereby independently control each modular wheel. For example, this could include having the processing device generate control instructions including a wheel orientation and/or a rate of rotation for each individual modular wheel.

In another example, the processing devices are configured to provide control instructions to the controllers and wherein the controllers of different modular wheels communicate to independently control each modular wheel. For example, the processing devices could generate control instructions including a direction and rate of travel for the object, with the controller for each modular wheel attached to that object then collaboratively determining a wheel orientation and/or rate of rotation for each wheel. In a further example, a master slave arrangement could be used, allowing a master modular wheel to calculate movements for each individual modular wheel, with that information being communicated to the other modular wheel controllers as needed.

In one example, the processing device is configured to determine an identity of one or more modular wheels or the object and then generate control instructions in accordance with the identity. For example, this can be used to ensure that control instructions are transmitted to the correct modular wheel. This could also be used to allow the processing device to retrieve an object or wheel configuration, allowing such configurations to be stored and retrieved based on the object and/or wheel identity as needed.

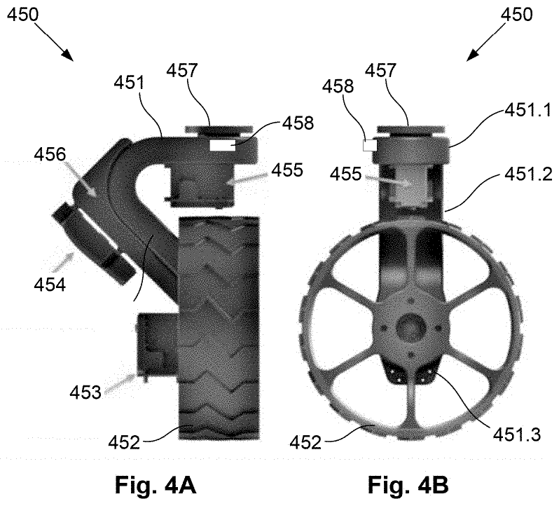

A first specific example of a modular wheel will now be described in more detail with reference to FIGS. 4A and 4B.

In this example, the modular wheel 450 includes a body 451 having a mounting 457 configured to be attached to the object. The body has a “7” shape, with an upper lateral portion 451.1 supporting the mounting 457, and an inwardly sloping diagonal leg 451.2 extending down to a hub 451.3 that supports the wheel 452. A drive 453 is attached to the hub, allowing the wheel to be rotated. A battery 456 is mounted on an underside of the sloping diagonal leg 451.2, with a controller 454 being mounted on an outer face of the battery. A steering drive 455 is also provided, which allows the body 451 to be rotated relative to the mounting 457, thereby allowing an orientation (heading) of the wheel to be adjusted. A sensor 458 is also shown attached to the upper lateral portion 451.1 of the body.

In one specific example, the modular wheel is designed to be a self-contained two degrees of freedom wheel. Each modular wheel can generate a speed and heading through the use of continuous rotation servos located behind the wheel and below the coupling at the top of the module. Their centres of rotation align to reduce torque during rotation. The wheel and top coupling use the ISO 9409-1404M6 bolt pattern to enable cross platform comparability. A generic set of adaptors can be used to enable rapid system assembly and reconfiguration.

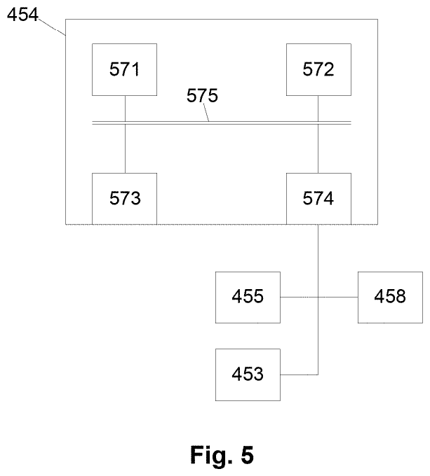

The controllers 454 could be of any appropriate form and an example is shown in FIG. 5.

In this example, the controller 454 includes at least one processing device 571, a memory 572, a wireless transceiver 573 and an interface 574, interconnected via a bus 575, as shown. In this example the interface 574 can be utilised for connecting the controller 454 to the drive 453, steering drive 455 and sensor 458. In use, the processing device 571 executes instructions in the form of applications software stored in the memory 572 to allow the required control processes to be performed, and specifically to allow sensor signals to be received and optionally processed, as well as controlling the drive 453 and steering drive 455. The applications software may include one or more software modules, and may be executed in a suitable execution environment, such as an operating system environment, or the like.

It will be understood from this that the controller could be any electronic processing device such as a microprocessor, microchip processor, logic gate configuration, firmware optionally associated with implementing logic such as an FPGA (Field Programmable Gate Array), or any other electronic device, system or arrangement.

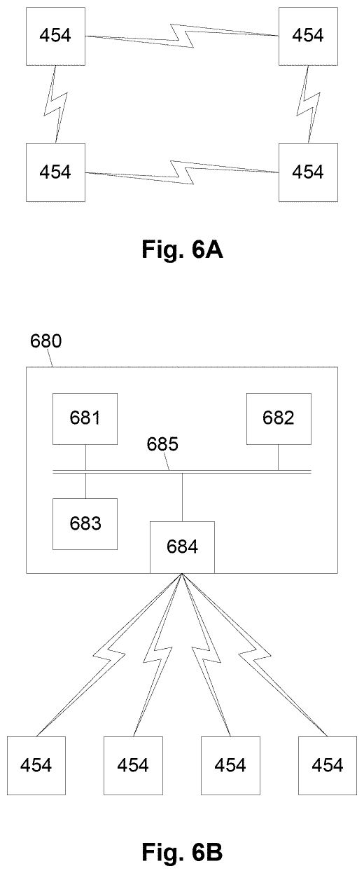

The wireless transceiver 573 allows onward wireless connectivity with controllers 454 of other modular wheels and or other processing systems, allowing the operation of multiple modular wheels to be coordinated. In this regard, coordination of multiple modular wheels could be achieved by having the controllers 454 communicate with each other as shown in FIG. 6A.

Alternatively, as shown in FIG. 6B, each controller could be in communication with a processing system 680, which coordinates operation of the controllers 454. In this example, the processing system 680 can be configured to receive sensor signals from the sensors 458 of each modular wheel, process these and generate control instructions to cause the controller 454 to control the drive 453 and steering drives 455 of each modular wheel 450.

In this example, the processing system 680 includes at least one microprocessor 681, a memory 682, an optional input/output device 683, such as a keyboard and/or display, and an external interface 684, interconnected via a bus 685, as shown. In this example the external interface 684 can be utilised for connecting the processing system 680 to the controllers 454, but also optionally peripheral devices, such as communications networks, or the like. Although a single external interface 684 is shown, this is for the purpose of example only, and in practice multiple interfaces using various methods (eg. Ethernet, serial, USB, wireless or the like) may be provided.

In use, the microprocessor 681 executes instructions in the form of applications software stored in the memory 682 to allow the required processes to be performed. The applications software may include one or more software modules, and may be executed in a suitable execution environment, such as an operating system environment, or the like.

Accordingly, it will be appreciated that the processing system 680 may be formed from any suitable processing system, such as a suitably programmed client device, PC, web server, network server, or the like. In one particular example, the processing system 680 is a standard processing system such as an Intel Architecture based processing system, which executes software applications stored on non-volatile (e.g., hard disk) storage, although this is not essential. However, it will also be understood that the processing system could be any electronic processing device such as a microprocessor, microchip processor, logic gate configuration, firmware optionally associated with implementing logic such as an FPGA (Field Programmable Gate Array), or any other electronic device, system or arrangement.

The processing system 680 may be associated with, and in particular co-located with or attached to the object being move, and/or could be located remotely to the object and in communication with the controller(s) 454 using wireless communications, including via direct, point to point, or communications networks. Furthermore, whilst the processing system 680 is shown as a single entity, it will be appreciated that this is not essential and distributed arrangements could be used.

In one specific example, the controller 454 is in the form of a Raspberry Pi providing both the wheels commands and Wi-Fi communication between modular wheels and/or communications networks. Built into the body or leg of each wheel is a four cell lithium polymer battery providing power. The battery can be accessed through a removable panel.

In one example, central control of the modular wheel system uses relative velocities to set the velocity, and hence rotation rate, of the individual modular wheels. Each modular wheel's pose (position and orientation) relative to the centre of the object can be used to determine the required velocity, which results in the ability to create traditional control systems by shifting the centre relative to the wheels. Different combinations of modules and centre points can create Ackerman steering, differential drive and nonholonomic omni directional movement. Such centralised control can be performed by the controllers 454, for example by nominating one controller as a master and others as slaves, having a centralised in-built controller optionally integrated into one of the modular wheels, and/or could be performed by the processing systems 680.

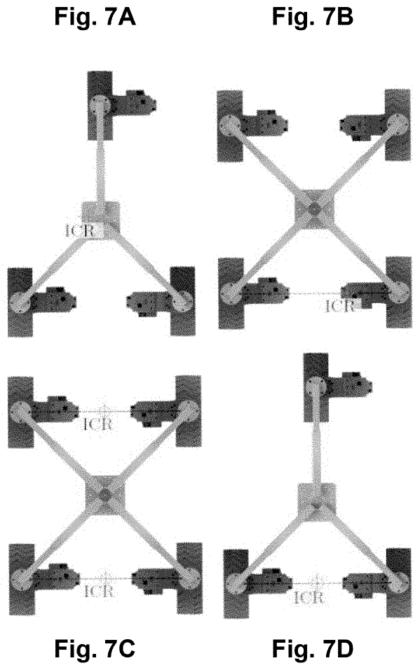

Example configurations are shown in FIGS. 7A to 7D. FIG. 7A shows a three-wheel configuration, with an instantaneous centre of rotation (ICR) placed centrally between all attached wheels producing nonholonomic omnidirectional configuration. FIG. 7B shows a four-wheel configuration with an ICR placed inline with the drive axis of the rear two wheels to provide Ackerman control. FIG. 7C shows a four-wheel configuration with an ICR placed inline between both sets of wheels produces differential drive or skid steer, whilst FIG. 7D shows a three-wheel configuration, with an ICR inline with a drive axis of to provide tricycle control. It will be appreciated that other drive configurations can also be employed and those shown are for the purpose of illustration only.

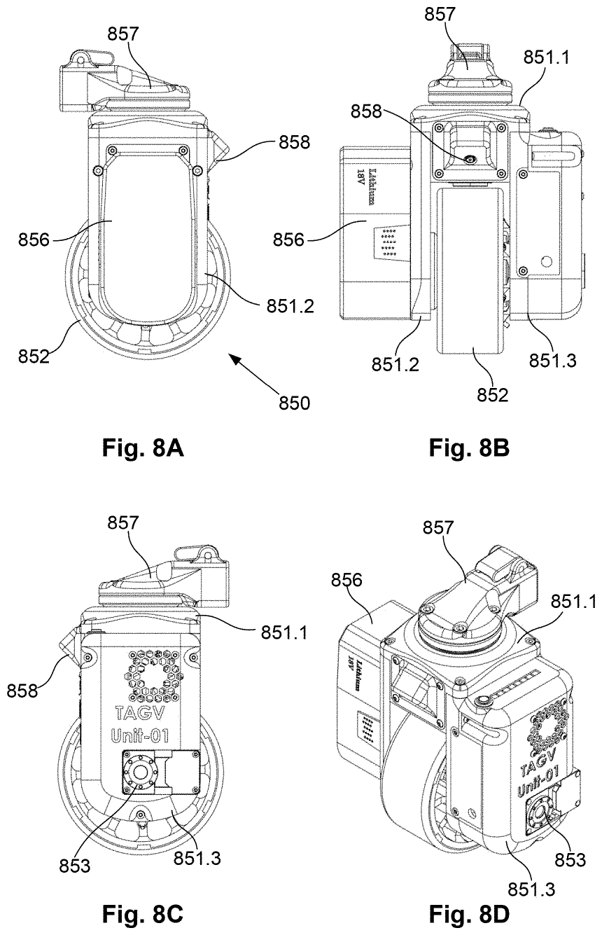

A further example modular wheel arrangement is shown in FIGS. 8A to 8D.

In this example, the modular wheel 850 includes a body having a mounting 857 configured to be attached to the object. The body has an inverted “U” shape, with an upper lateral portion 851.1 supporting the mounting 857, and downwardly projecting arms 851.2, 851.3 that support the battery 856, and the drive 853 and controller (not shown) respectively. A steering drive (not shown) is also provided in the lateral portion 851.1 of the body, which allows the body to be rotated relative to the mounting 857, thereby allowing an orientation (heading) of the wheel to be adjusted.

Examples of the processes for control movement of objects will now be described in further detail.

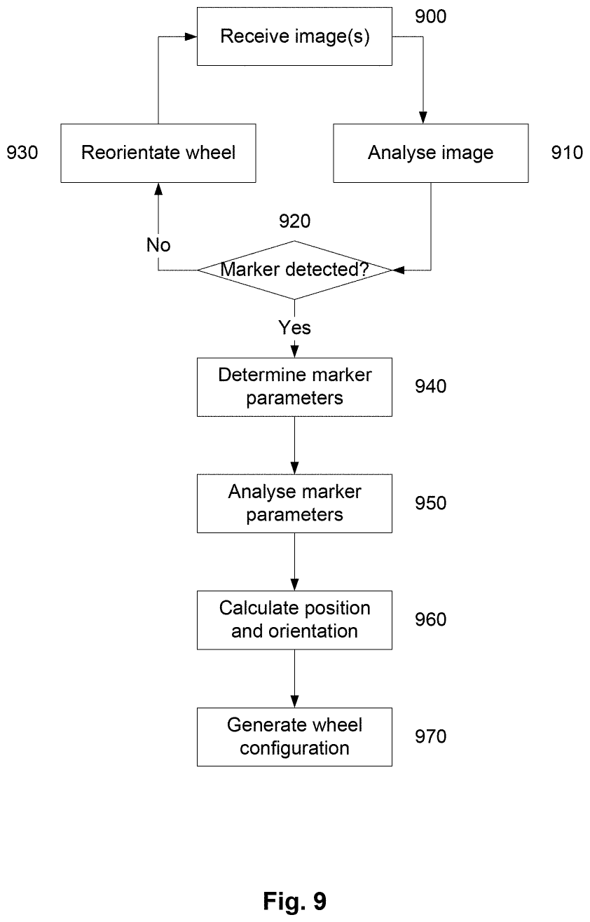

A first example involving the detection of markers will now be described with reference to FIG. 9.

In this example, at step 900, the processing devices receive images from imaging devices on each of the modular wheels attached to the object. At step 910, the processing devices analyse images in an attempt to identify a marker, such as an AprilTag, fiducial markers, LEDs, or similar. If a marker is not detected at step 920, the processing devices re-orientate the modular wheels and repeat steps 900 and 910, with this process continuing until a marker is detected, or until a full 360° rotation has been completed.

Once a marker is detected, at step 940 the processing devices determine marker parameters, such as a size or shape of the marker, an illumination sequence and/or colour, or a location of the marker within the image. At step 950 the processing devices analyse marker parameters, and use these to calculate a position and/or orientation of the wheel relative to the marker at step 960, allowing this to be used generate the wheel configuration at step 970.

Thus, for example, if the marker includes an AprilTag positioned either on the object or in the environment, then the processing device 680 can calculate a position of each modular wheel relative to the AprilTag by analysing an image captured by each imaging device, before then calculating a relative position of each of the modular wheels.

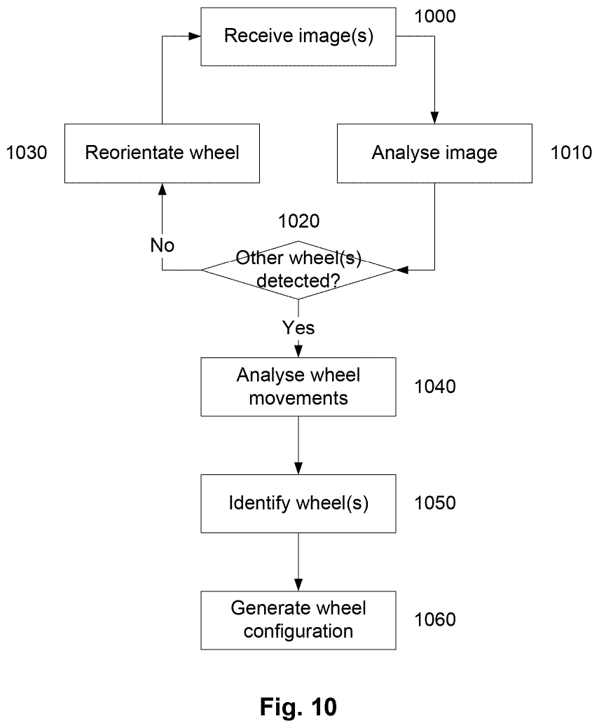

A second example involving the detection of other wheels will now be described with reference to FIG. 10.

In this example, at step 1000, the processing devices receive images from imaging devices on each of the modular wheels attached to the object. At step 1010, the processing devices analyse images in an attempt to identify another wheel, which could include a passive wheel, but more typically is another modular wheel. This can be achieved using any suitable technique, such as using image recognition, or by detecting tags or other coded data on the other wheels. If another wheel is not detected at step 1020, the processing devices re-orientate the modular wheel at step 1030 and repeat steps 1000 and 1010. This continues until another wheel is detected, or until a full 360° rotation has been completed.

Once another modular wheel is detected, at step 1040 the processing devices operate to analyse movement of the other wheels from the captured images. In this regard, if all of the modular wheels are moving in different ways, such as changing orientation in different directions or at different rates, analysing the images captured of the other wheels allows the other wheel to be identified at step 1050.

Once the position of the other modular wheel and the orientation of the modular wheel are known, these can be used to determine the relative position of the modular wheels. Repeating this process for all modular wheels allows relative positions to be determined, which in turn allows the wheel configuration to be generated at step 1060. In particular, this is typically achieved by using measurements from each wheel to calculate separate robot states, which are then combined with a filter Kalam/Monte Carlo or similar approach to construct an overall wheel configuration model.

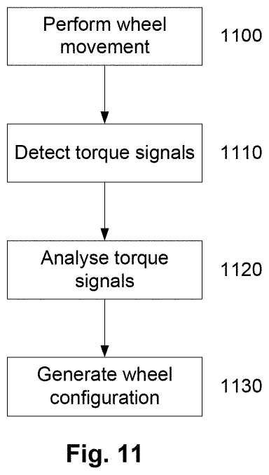

A further example involving the detection of forces on the wheels will now be described with reference to FIG. 11.

In this example, at step 1100, the processing devices cause one or more of the modular wheels to perform a defined wheel movement. In this regard, it is not required that movement actually occurs, but rather that the modular wheel is actuated, thereby causing forces to be imparted on the object that would cause the object to move if other wheels were not stationary.

At step 1110 torque signals are detected from torque sensors mounted on one or more of the modular wheels, with the torque signals being analysed at step 1120 to derive candidate wheel arrangements. These can then be combined with a filter Kalam/Monte Carlo or similar approach to generate an overall wheel configuration model at step 1130.

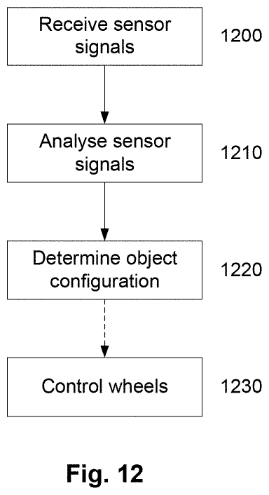

An example of a process for determining an object configuration will now be described with reference to FIG. 12.

In this example, at step 1200 sensor signals are received from one or more of the sensors, with these being analysed at step 1210 and used to determine an object configuration at step 1220. This could involve examining a physical extent of the object, based for example on edge detection performed on images of edges of the object, or could involve determining an object identity from coded data presented on the object, and using this to retrieve a previous stored object configuration from a remote database or similar. At step 1230 the object configuration is used to control the wheels, for example, calculating control instructions for each modular wheel so that the object is moved whilst ensuring that the object does not inadvertently impinge on the surrounding environment, or similar.

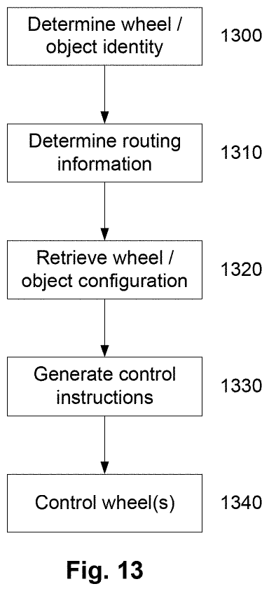

An example of a process for controlling an object will now be described in further detail with reference to FIG. 13.

In this example, at step 1300 a wheel and/or object identity is determined, for example through the detection of coded data in a manner similar to that described above. Following this, at step 1310 the object and/or wheel identity is used to retrieve routing data associated with the object, as well as a wheel and/or object configuration at step 1320. The routing data could be a predefined route through the environment, or could include a target destination, with the processing devices operating to calculate a route.

Following this the processing devices can generate control instructions at step 1330 in accordance with the routing data, as well as the wheel and/or object configurations. For example, the wheel configuration can be used to translate the route into specific rotation and/or orientation commands for each of the modular wheels, based on the wheel layout, thereby ensuring the instructions generated for each modular wheel reflect the movement required in order for the object to traverse the route.

Following this at step 1340, the control instructions can be transferred to the controllers 454, allowing the object to be moved in accordance with the routing data by controlling the wheels and thereby follow the route.

It will be appreciated that this process could be repeated periodically, such as every few seconds, allowing the processing devices to substantially continuously monitor movement of the object, to ensure the route is followed, and to take interventions if needed, for example to correct any deviation from an intended travel path. This also reduces the complexity of the control instructions needed to be generated on each loop of the control process, allowing complex movements to be implemented in as a series of simple control instructions.

Accordingly, it will be appreciated that the above described system provides modular wheels that can be attached to objects to allow the objects to be moved within an environment. The modular wheels include sensors that can be used either to sense markings within the environment to control movement of the object, or to sense markings or wheels that can be used to generate a wheel configuration, which can in turn be used to generate commands required to move the wheels and thereby move the object in accordance with the routing information.

Throughout this specification and claims which follow, unless the context requires otherwise, the word “comprise”, and variations such as “comprises” or “comprising”, will be understood to imply the inclusion of a stated integer or group of integers or steps but not the exclusion of any other integer or group of integers. As used herein and unless otherwise stated, the term “approximately” means±20%.

Persons skilled in the art will appreciate that numerous variations and modifications will become apparent. All such variations and modifications which become apparent to persons skilled in the art, should be considered to fall within the spirit and scope that the invention broadly appearing before described.

1) A system for moving an object within an environment, wherein the system includes:
a) one or more modular wheels configured to move the object, wherein the one or more modular wheels include:
i) a body configured to be attached to the object;
ii) a wheel;
iii) a drive configured to rotate the wheel; and,
iv) a sensor mounted to the body; and,
b) one or more processing devices configured to:
i) receive sensor signals from one or more sensors;
ii) analyse the sensor signals;
iii) generate a wheel configuration indicative of a wheel configuration of the one or more modular wheels; and,
iv) control the one or more modular wheels in accordance with the wheel configuration.

2) A system according to claim 1, wherein at least one modular wheel includes a steering drive configured to adjust an orientation of the wheel and wherein the one or more processing devices are configured to control the steering drive to thereby change an orientation of the wheel and thereby steer the object.

3) A system according to claim 1 or claim 2, wherein the one or more processing devices are configured to generate a wheel configuration for each modular wheel.

4) A system according to claim 3, wherein the wheel configuration is indicative of at least one of:
a) a position of one or more modular wheels relative to each other;
b) a position of one or more modular wheels relative to one or more passive wheels;
c) a position of one or more modular wheels relative to the object;
d) a position of one or more modular wheels relative to an environment;
e) a position of one or more modular wheels relative to one or more markers;
f) an orientation of one or more modular wheels relative to each other;
g) an orientation of one or more modular wheels relative to one or more passive wheels;
h) an orientation of one or more modular wheels relative to the object;
i) an orientation of one or more modular wheels relative to an environment;
j) an orientation of one or more modular wheels relative to one or more markers;
k) a wheel identity of each modular wheel; and,
l) a relative position, relative orientation and wheel identity of each modular wheel.

5) A system according to claim 4, wherein the one or more markers are at least one of:
a) provided on the object;
b) provided in the environment;
c) provided on one or more modular wheels;
d) one or more modular wheels;
e) one or more passive wheels;
f) one or more active markers;
g) a part of the object;
h) Fiducial markers; and,
i) April tags.

6) A system according to any one of the claims 1 to 5, wherein the sensor is an imaging device that is configured to capture one or more images and wherein one or more processing devices are configured to generate the wheel configuration by analyzing the one or more images.

7) A system according to claim 6, wherein the one or more processing devices are configured to:
a) analyze images captured with at least one modular wheel in multiple orientations; and,
b) use the images to generate the configuration data.

8) A system according to claim 6 or claim 7, wherein the one or more processing devices are configured to:
a) monitor images from an imaging device as an orientation of the respective modular wheel is varied; and,
b) determine when an image including a marker is captured.

9) A system according to any one of the claims 1 to 8, wherein the one or more processing devices are configured to:
a) identify an image including a marker;
b) determine a wheel orientation when the identified image was captured; and,
c) use the wheel orientation to generate the wheel configuration.

10) A system according to claim 9, wherein the one or more processing devices are configured to:
a) analyze images to identify at least one marker parameter; and,
b) generate the wheel configuration using the marker parameter.

11) A system according to claim 10, wherein the marker parameter includes at least one of:
a) a marker size;
b) a marker shape;
c) a marker position;
d) a marker colour;
e) a marker illumination sequence;
f) a marker pattern; and
g) a marker orientation.

12) A system according to any one of the claims 9 to 11, wherein the one or more processing devices are configured to:
a) determine when an image including a marker is captured;
b) use the image of the marker to determine a wheel position and orientation relative to the marker; and,
c) use the wheel position and orientation for each modular wheel to generate the wheel configuration.

13) A system according to any one of the claims 1 to 12, wherein the one or more processing devices are configured to:
a) determine when a first imaging device of a first modular wheel captures an image of a second modular wheel;
b) analyse one or more images from the first modular wheel to determine a wheel identity of at least one second modular wheel; and,
c) generate a wheel configuration at least in part using the determined wheel identity.

14) A system according to claim 13, wherein the one or more processing devices are configured to:
a) cause movement of one or more second modular wheels;
b) analyse multiple images from the first imaging device to detect movement of the at least one second modular wheel; and,
c) use results of the analysis to determine an identity of the at least one second wheel.

15) A system according to claim 13 or claim 14, wherein the one or more processing devices are configured to determine a wheel identity of at least one second modular wheel using visual markings associated with the at least one second modular wheel.

16) A system according to any one of the claims 1 to 15, wherein the sensor is a force sensor that is configured to capture forces between the body and the object and wherein one or more processing devices are configured to generate the wheel configuration by analyzing captured forces.

17) A system according to claim 16, wherein the one or more processing devices are configured to:
a) control the one or more modular wheels to cause the modular wheels to perform defined movements; and,
b) analyze captured forces in accordance with the defined movements to generate the configuration data.

18) A system according to claim 17, wherein the one or more processing devices are configured to:
a) cause a first modular wheel to perform defined movements; and,
b) use captured forces from the force sensors of the first and one or more second modular wheels to thereby generate the wheel configuration.

19) A system according to any one of the claims 1 to 18, wherein the one or more processing devices are configured to:
a) receive sensor signals from one or more sensors;
b) analyse the sensor signals;
c) identify instructions from the sensor signals; and,
d) control the one or more modular wheels in accordance with the instructions.

20) A system according to claim 19, wherein the sensor signals are indicative of markings provided in the environment.

21) A system according to claim 20, wherein the sensor includes an imaging device and wherein the one or more processing devices are configured to analyse images captured by the imaging device to detect the markings.

22) A system according to claim 21, wherein the markings include line markings in the environment and the one or more processing devices are configured to control the one or more modular wheels to move the object in accordance with the line markings.

23) A system according to claim 22, wherein the line markings include encoded line markings and the one or more processing devices are configured to follow a route in accordance with the encoded line markings.

24) A system according to any one of the claims 1 to 23, wherein the one or more processing devices are configured to:
a) determine an object configuration; and,
b) control the modular wheels at least partially in accordance with the object configuration.

25) A system according to claim 24, wherein the object configuration is indicative of at least one of:
a) a physical extent of the object; and,
b) movement parameters associated with the object.

26) A system according to claim 24 or claim 25, wherein the sensor is an imaging device that is configured to capture one or more images and wherein one or more processing devices are configured to determine the object configuration by analyzing the one or more images.

27) A system according to any one of the claims 24 to 26, wherein the one or more processing devices are configured to:
a) determine an identity for at least one of:
i) the object; and,
ii) for at least one modular wheel attached to the object; and,
b) determine the object configuration at least in part using the object identity.

28) A system according to any one of the claims 1 to 27, wherein the one or more processing devices are configured to:
a) determine routing data indicative of at least one of:
i) a travel path; and,
ii) a destination; and,
b) control at least one of the drive and a steering drive in accordance with the routing data and the wheel configuration.

29) A system according to claim 28, wherein the routing data is indicative of at least one of:
a) a permitted object travel path;
b) permitted object movements;
c) permitted proximity limits for different objects;
d) permitted zones for objects; and,
e) denied zones for objects.

30) A system according to claim 28 or claim 29, wherein the one or more processing devices are configured to:
a) determine an identity for at least one of:
i) the object; and,
ii) for at least one modular wheel attached to the object; and,
b) determine the routing data at least in part using the object identity.

31) A system according to claim 30, wherein the one or more processing devices are configured to determine the object identity at least in part using a network identifier.

32) A system according to claim 30 or claim 31, wherein the one or more processing devices are configured to determine the object identity using machine readable coded data.

33) A system according to claim 32, wherein the machine readable coded data is visible data, the sensors are imaging devices and wherein the one or more processing devices are configured to analyse images captured by the imaging devices to detect the machine readable coded data.

34) A system according to claim 32 or claim 33, wherein the machine readable coded data is encoded on a tag, and wherein the one or more processing devices are configured to receive signals indicative of the machine readable coded data from a tag reader.

35) A system according to claim 34, wherein the tags are at least one of:
a) short range wireless communications protocol tags;
b) RFID tags; and,
c) Bluetooth tags.

36) A system according to any one of the claims 1 to 35, wherein the system includes one or more passive wheels mounted to the object.

37) A system according to any one of the claims 1 to 36, wherein the at least one modular wheel includes a transceiver configured to communicate wirelessly with the one or more processing devices.

38) A system according to any one of the claims 1 to 37, wherein the one or more processing devices include a controller associated with each of the one or more modular wheels.

39) A system according to claim 38, wherein the one or more processing devices include a control processing device configured to:
a) generate control instructions at least in part using the determined wheel configuration; and,
b) provide the control instructions to one or more controllers, the one or more controllers being responsive to the control instructions to control one or more respective drives and thereby move the object.

40) A system according to claim 39, wherein the one or more processing devices are configured to provide respective control instructions to each controller to thereby independently control each modular wheel.

41) A system according to claim 39, wherein the one or more processing devices are configured to provide control instructions to the one or more controllers and wherein the one or more controllers communicate to independently control each modular wheel.

42) A system according to any one of the claims 39 to 41, wherein the control instructions include at least one of:
a) a wheel orientation for each wheel; and,
b) a rate of rotation for each wheel.

43) A system according to any one of the claims 39 to 42, wherein the control instructions include a direction and rate of travel for the object, and wherein the controllers use the control instructions to determine at least one of:
a) a wheel orientation for each wheel; and,
b) a rate of rotation for each wheel.

44) A system according to any one of the claims 1 to 43, wherein the system is configured to steer the object by at least one of:
a) differentially rotating multiple modular wheels; and,
b) changing an orientation of one or more modular wheels.

45) A system according to any one of the claims 1 to 44, wherein at least one modular wheel includes a mounting attached to the body, the mounting being configured to couple the body to the object.

46) A system according to any one of the claims 1 to 45, wherein the one or more modular wheels include a power supply configured to power at least one of:
a) the drive;
b) a controller;
c) a transceiver; and,
d) a steering drive.

47) A system according to any one of the claims 1 to 46, wherein the system includes a plurality of modular wheels.

48) A system according to any one of the claims 1 to 47, wherein the object includes a platform and wherein the at least one modular wheel is attached to the platform.

49) A system according to any one of the claims 1 to 48, wherein the object includes an item supported by the platform.

50) A method for moving an object within an environment, wherein the method includes:
a) providing one or more modular wheels configured to move the object, wherein the one or more modular wheels include:
i) a body configured to be attached to the object;
ii) a wheel;
iii) a drive configured to rotate the wheel; and,
iv) a sensor mounted to the body; and,
b) in one or more processing devices:
i) receive sensor signals from one or more sensors;
ii) analyse the sensor signals;
iii) generate a wheel configuration indicative of a wheel configuration of the one or more modular wheels; and,
iv) control the one or more modular wheels in accordance with the wheel configuration.

51) A modular wheel for moving an object within an environment, wherein the modular wheel includes:
a) a body configured to be attached to the object;
b) a wheel;
c) a drive configured to rotate the wheel; and,
d) a sensor mounted to the body.
